(19) United States
(12) Patent Application Publication
(10) Pub. No.: US 2008/0298663 A1
(43) Pub. Date: Dec. 4, 2008

(54) Task Specific Reconstruction of Functional Medical Scans

(75) Inventor: David Schottlander, Sutton Courtenay (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Medical Solutions, Malvern, PA (US)

(21) Appl. No.: 12/130,560

(22) Filed: May 30, 2008

(30) Foreign Application Priority Data
Jun. 1, 2007 (GB) 0710428.4

(51) Int. Cl. G06K 9/74

(52) U.S. Cl. 382/131

(57) ABSTRACT

The invention addresses the problem of algorithm specific artefacts introduced by reconstruction of functional medical scans. After a general purpose reconstruction is performed, regions of interest are identified from the data and task specific reconstruction of the region(s) of interest is carried out. The reconstructed data can be displayed (for example) as a report or image overlay.

The invention concerns the reproducible and accurate measurement of radio-tracer distribution in a body from the results of functional medical scanning procedures such as Positron Emission Tomography (PET) or Single Photon Emission Computed Tomography (SPECT).

Reconstruction is a step in a functional medical scanning procedure where an image is generated from the data acquired during the scan, the image depicting the localisation and concentration of radioisotope within the plane of the organ that was scanned.

For example, during a PET procedure, a subject is injected with a radioisotope such as [18F]-labeled 2-deoxyglucose (FDG) and, in time, the distribution of tracer throughout the body is measured by detecting the radiation produced when positrons emitted by the 18F radiolabel collide with electrons in neighboring atoms. This energy (in the form of gamma rays) is emitted as a pair of photons at approximately 180 degrees to each other and detection of such a pair allows a coincidence line to be deduced, along which the source of the radiation is assumed to lie.

Reconstruction algorithms use the information derived from a large number of such measurements at a large number of angular and linear positions to generate the image depicting the tracer concentration.

The reconstructed image provides a convenient tool for assessing the results of the scan and drawing inferences concerning metabolic reactions of the subject.

General purpose reconstruction techniques introduce algorithm specific artefacts. For example, Filtered Back Projection (FBP) (Kak and Slaney 1988) blurs the data uniformly, introducing strong correlations between neighbouring voxels.

Maximum A Posteriori (MAP) (Green 1990) and Maximum Likelihood Expectation Maximum (ML-EM) (Shepp and Vardi 1982) (Lange and Carson 1984) approaches both introduce non-uniform blurring and correlations that are spatially variant (Barrett, Wilson et al. 1994) and, in the case of dynamic data, temporally variant.

This causes sub-optimality in terms of task-specific operations performed by the user, including regional quantification, lesion detection, computer aided analysis and automated comparison against normal databases.

Thus far, work on addressing these problems has exploited the quantitative nature of the reconstructed PET/SPECT data, as illustrated generally with phantom experiments. Specific methods have been developed for the case of MAP reconstruction algorithms for achieving approximations of either uniform variance or uniform bias (Stayman 2002). In addition, effort has been directed towards the problem of how to control the smoothing by the use of informative priors onto the cost function (Comtat, Kinahan et al. 2002).

For ML-EM reconstruction, effort has been focussed on establishing the variance/bias at different points of convergence and finding optimal post-reconstruction smoothing parameters (Nuyts 2001). For FBP, effort has been directed towards identifying non-uniform blurring kernels to try and preserve edges.

All of these approaches involve developing new reconstruction algorithms, each of which introduces its own inaccuracies and variability, thus compounding the problems associated with inter-study comparisons.

Following reconstruction, post-analysis tasks are performed: these include lesion detection, region of interest (ROI) analysis and comparison with databases.

The invention reduces the problems associated with general purpose reconstruction by providing an approach that is optimized for the task under consideration which reduces inter-study variability.

A number of techniques are known that are applicable to reconstruction of specific regions of interest, see for example D. C. Schottlander, T. Kadir, J. M. Declerck, and M. Brady, “Unbiased quantification of tomographic data by projecting continuous regions of interest,” presented at the IEEE Nuclear Science Symposium and Medical Imaging Conference, San Diego, 2006; R. H. Huesman, “A new fast algorithm for the evaluation of regions of interest and statistical uncertainty in computed tomography,” Physics in Medicine and Biology, vol. 29, no. 5, pp. 543-52, 1984, UK Journal-Paper English 0031-9155. 92, 98 and R. E. Carson, “A maximum likelihood method for region-of-interest evaluation in emission tomography,” Journal of Computer Assisted Tomography, vol. 10, pp. 654-63, 1986.

According to the invention, a method of processing data acquired during the performance of a functional medical scan comprises the steps set out in claim 1 attached hereto.

The invention will now be described with reference to:

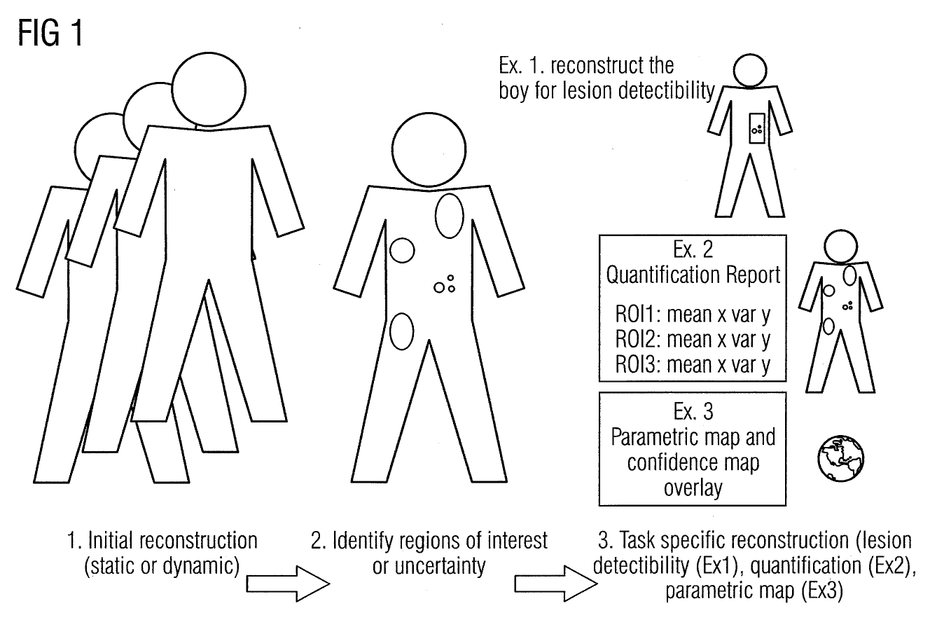

FIG. 1 which illustrates schematically, the essential steps of the invention and

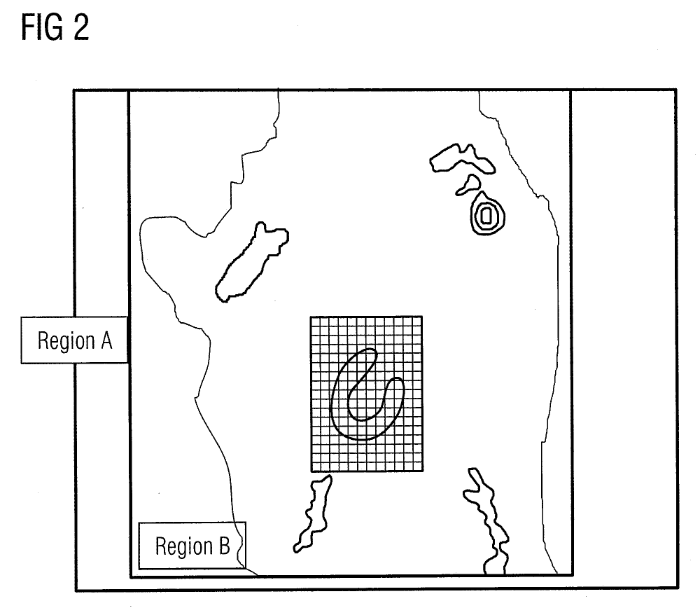

FIG. 2 which illustrates application of the invention to the problem of Quantititative cardiac PET imaging.

Referring to FIG. 1, in step 1, the data acquired during a functional medical scan such as PET or SPECT is subjected to a general purpose reconstruction. A number of such reconstruction types is possible including FBP, MAP and ML-EM. The operation could be performed on either static or dynamic data.

In step 2, regions of interest in the reconstructed image are identified. This could be done using any of a number of methods including computer aided detection; registration with an atlas; visual inspection and qualities such as contrast or brightness.

In step 3, task specific reconstruction of the regions of interest identified at step 2 is performed. Possible approaches here include parametric map reconstruction using a model based approach such as compartment modelling; reconstruction to maximize lesion detectability; reconstruction of average image intensity values and associated confidence for each ROI and reconstruction of ROI homogeneity index.

The results of the task specific reconstruction and/or confidence values, can be displayed or presented as a report or graphic overlay.

### EXAMPLE

Quantititative cardiac PET imaging requires accurate data measurements from the myocardium as a precursor to performing weighted model based fitting to a physiological model of myocardial blood flow. One way of achieving this is to reconstruct the data using an iterative algorithm, executed to, or close to, convergence. This implies running the algorithm for many hundreds of iterations, which is prohibitively expensive from a computational point of view. Task specific reconstruction provides a means of achieving this by using the following steps:
1. reconstruct the entire volume using a fast reconstruction algorithm such as filtered back-projection.
2. the user manually places a bounding box to encompass the entire myocardium volume using a software program.
3. divide the volume into two regions, Region A is inside the bounding box and Region B is outside the bounding box. Divide region a into a fine grid of rectangular volume elements.
4. reconstruct the data a second time using the new reconstruction basis consisting of the Region A mesh and Region B (using, e.g. a regional reconstruction algorithm, see for example see for example D. C. Schottlander, T. Kadir, J. M. Declerck, and M. Brady, referenced above). Due to the reduced number of voxels, this algorithm can be executed to convergence.

### REFERENCES

Barrett, H. H., D. W. Wilson, et al. (1994). “Noise properties of the {EM} algorithm.˜{I}. Theory.” Physics in Medicine and Biology 39(5): 833-46.
Comtat, C., P. E. Kinahan, et al. (2002). “Clinically feasible reconstruction of {3D} whole-body {PET/CT} data using blurred anatomical labels.” Physics in Medicine and Biology 47: 1-20.
Green, P. J. (1990). “Bayesian reconstructions from emission tomography data using a modified {EM} algorithm.” IEEE Transactions on Medical Imaging 9(1): 84-93.
Kak, A. C. and M. Slaney (1988). Principles of computerized tomographic imaging. New York, IEEE Press.
Lange, K. and R. E. Carson (1984). “{EM} reconstruction algorithms for emission and transmission tomography.” Journal of Computer Assisted Tomography 8: 306-316.
Nuyts, J. (2001). On estimating the variance of smoothed {MLEM} images. IEEE Nuclear Science Symposium.
Shepp, L. A. and Y. Vardi (1982). “Maximum Likelihood Reconstruction in Positron Emission Tomography.” IEEE Transactions on Medical Imaging 1(2): 113-122.
Stayman, J. W. (2002). Spatial Resolution in Penalized-Liklihood Image Reconstruction, University of Michagin.

1. A method of processing data acquired during the performance of a functional medical scan comprising the steps of:
performing a general purpose reconstruction of the data;
identifying regions of interest (ROIs) in the image resulting from the general purpose reconstruction and
performing a task specific reconstruction of the data corresponding to the regions of interest so identified.

2. The method of claim 1, where the general purpose reconstruction comprises a Filtered Back Projection (FBP).

3. The method of claim 1, where the general purpose reconstruction comprises a Maximum A Posteriori (MAP).

4. The method of claim 1, where the general purpose reconstruction comprises a method based on Maximum Likelihood Expectation Maximisation (ML-EM).

5. The method of any of claims 1-4 where the task specific reconstruction comprises a Parametric map reconstruction within the region using, for example, compartment model analysis.

6. The method of any of claims 1-4 where the task specific reconstruction comprises a reconstruction to maximise lesion detectability by maximizing the contrast within the nominated region.

7. The method of any of claims 1-4 where the task specific reconstruction comprises a reconstruction of regional intensity values and associated confidence values.

8. The method of any of claims 1-4 where the task specific reconstruction comprises a reconstruction of a regional ROI homogeneity index.
